(19) United States
(12) Patent Application Publication
(10) Pub. No.: US 2011/0296724 A1
(43) Pub. Date: Dec. 8, 2011

(54) ELECTRONIC DEVICE WITH PATTERN-DISPLAYING FUNCTION

(75) Inventors: SHIH-WEI YANG, Shindian (TW); KAI-RONG LIAO, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/978,508

(22) Filed: Dec. 24, 2010

(30) Foreign Application Priority Data
Jun. 4, 2010 (CN) 201010192238.0

(51) Int. Cl. G09F 13/00

(52) U.S. Cl. 40/541

(57) ABSTRACT

An electronic device is provided. The electronic device includes a housing defining a chamber and at least one light source. The housing has an inner surface and an opposite outer surface. The outer surface defines a plurality of light-transmitting recesses that have been configured in a desired pattern. Each of the recesses has a gradually changing thickness. The at least one light source is fixed in the chamber and transmits light to the recesses, thereby displaying the desired pattern of the recesses on the outer surface of the housing.

### BACKGROUND

1. Technical Field

The present disclosure relates to electronic devices and, specifically, to an electronic device with a pattern-displaying function.

2. Description of Related Art

The function of displaying patterns of an electronic device is usually achieved by the following configuration. Light-guiding pillars for transmitting beams of light are provided. The patterns are printed on a film. The film having patterns is adhered to an inner surface of a housing of the electronic device, and light-guiding pillars are positioned under patterns. A light source, such as an LED is located under the light-guiding pillars for emitting light. The emitted light is transmitted by the light-guiding pillars to the inner surface of the housing, thereby displaying the patterns at an outer surface of the housing. The housing is usually transparent, and an opaque film adheres to the inner surface of the housing, around the patterns to prevent light leakages.

However, the assembly of the light-guiding pillars and the opaque film to the electronic device can be complex and costly.

Therefore, there is room for improvement within the art.

### BRIEF DESCRIPTION OF THE DRAWINGS

Many aspects of the present electronic device can be better understood with reference to the drawings. The components in the drawings are not necessarily drawn to scale, the emphasis instead being placed upon clearly illustrating the principles of the present electronic device.

FIG. 1 is a perspective view of the present electronic device according to an exemplary embodiment.

FIG. 2 is a cross-section view of the electronic device shown in FIG. 1 taken along line II-II.

FIG. 3 is an amplificatory view of the III portion of FIG. 2.

FIG. 4 is schematic cross-section view of the present electronic device according to another exemplary embodiment.

### DETAILED DESCRIPTION

### Embodiment 1

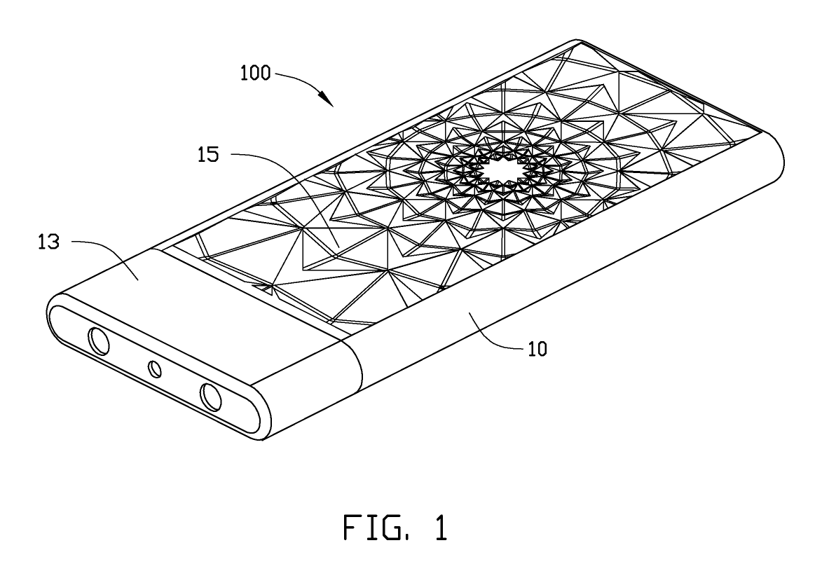

FIG. 1 shows an exemplary electronic device 100, such as a mobile phone, or a personal digital assistant (PDA). In this exemplary embodiment, the electronic device 100 is a mobile phone. The electronic device 100 includes a housing 10 and at least one light source 22.

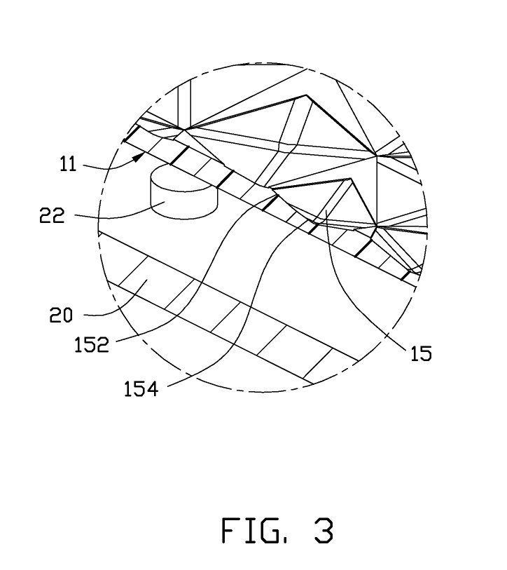

The housing 10 has an inner surface 11 and an opposite outer surface 13. The outer surface 13 defines a plurality of light-transmitting recesses 15 (best shown in FIG. 3). The recesses 15 are configured in a desired pattern structure, such as a decorative figure, or a trade logo. The housing 10 defines a chamber 17 therein.

The housing 10 may be made of plastic being opaque or capable of partially transmitting light, such as acrylonitrile-butadiene-styrene (ABS), polyvinyl chloride (PC), polyvinyl chloride (PVC) or high impact polystyrene (HIPS). The light-transmitting capability of the plastic material improves with the decrease of the thickness. Thus, due to the thinness of the recesses 15, the recesses 15 have a better light-transmitting capability than the remainder of the housing 10. Also, if any portion of one recess 15 has the same thickness, the light transmitting capability of every portion of the recess 15 is the same, that is, the transmitted through light will have substantially the same intensity or brightness. Accordingly, it is difficult to present a relief shadow pattern. For this reason, each of the recesses 15 has a gradually changing thickness. For achieving improved clarity, the thickness from the open portion 152 to the bottom portion 154 of each recess 15 gradually decreases. For example, the thickness of the remainder of the housing 10 may be 0.8 mm, and the thickness from the open portion 152 to the bottom portion 154 of each recess 15 may gradually change from about 0.8 mm to about 0.4 mm. The recesses 15 may be formed in the housing 10 by a single injection molding or incising after being molded using a machine.

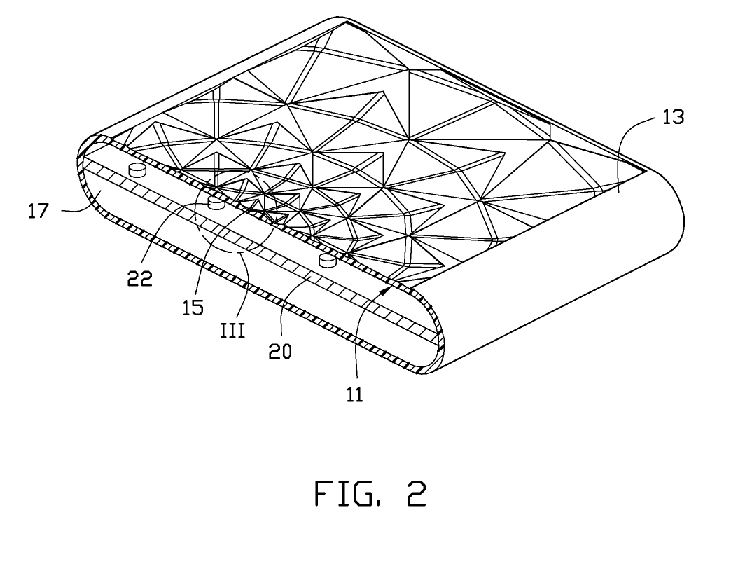

Referring to FIG. 2 and FIG. 3, the at least one light source 22 is fixed in the chamber 17. In this exemplary embodiment, the at least one light source 22 is located on a printed circuit board (PCB) 20 in the chamber 17 of the housing 10. In other embodiments, the at least one light source 22 can be fixed in any other positions, such as the inner surface 11 of the housing 10 or a fixing element located in the chamber 17.

In use, the at least one light source 22 transmits light to the recesses 15 that have been configured as a pattern structure, thereby displaying the desired pattern on the outer surface 13 of the housing 10. Furthermore, because each recess 15 has a gradually changing thickness, the brightness or intensity of the light transmitting may gradually change, thereby a relief shadow pattern with a three-dimensional effect can be presented.

### Embodiment 2

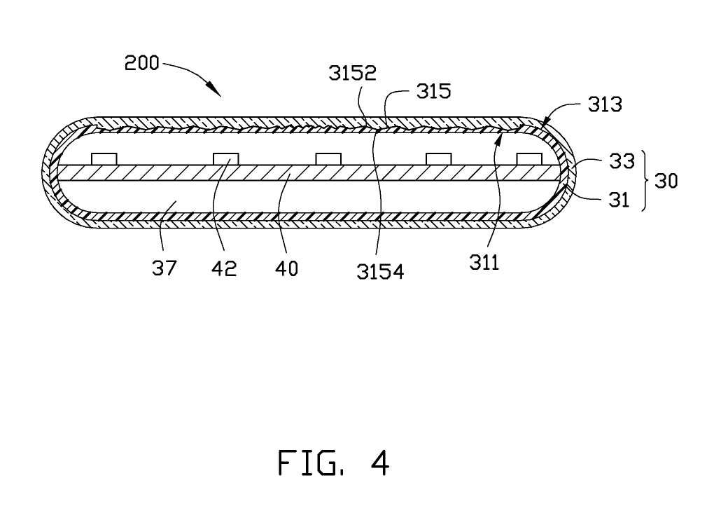

FIG. 4 shows another exemplary electronic device 200 which includes a housing 30 and at least one light source 42. The housing 30 defines a chamber 37 therein. Unlike the first exemplary embodiment, the housing 30 has a first layer 31 and a transparent second layer 33.

The first layer 31 has an inner surface 311 and an opposite outer surface 313. The outer surface 313 defines a plurality of light-transmitting recesses 315. The recesses 315 are defined in a desired pattern structure, such as a decorative figure, or a trade logo. The first layer 31 may be made of opaque plastic or plastic that is capable of partially transmitting light, such as ABS, PC, PVC, or HIPS. Each of the recesses 315 has a gradually changing thickness. For achieving improved clarity, thickness from the open portion 3152 to the bottom portion 3154 of each recess 315 gradually decreases. Due to the thinness of the recesses 315, the recesses 315 have a better light-transmitting capability than the remainder of the first layer 31. The first layer 31 may have pigment added in to achieve a desired color.

The recesses 315 may be formed in the first layer 31 by a single injection molding or incising after being molded using a machine.

The second layer 33 may be formed on the outer surface 313 by injection molding. The second layer 33 may be made of transparent plastic, such as polymethyl methacrylate.

The at least one light source 42 is fixed in the chamber 37. In this exemplary embodiment, the at least one light source 42 is located on a printed circuit board 40 in the chamber 37.

In use, the at least one light source 42 transmits light to the recesses 315 that has been configured as a pattern structure, thereby displaying the desired pattern outside the transparent second layer 33.

However, even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic device, comprising:
a housing defining a chamber and having an inner surface and an opposite outer surface, the outer surface defining a plurality of light-transmitting recesses configured in a desired pattern, each of the recesses having a gradually changing thickness; and
at least one light source fixed in the chamber;
wherein the at least one light source transmits light to the recesses, thereby displaying the desired pattern of the recesses on the outer surface of the housing.

2. The electronic device as claimed in claim 1, wherein the thickness from the open portion to the bottom portion of each recess gradually decreases.

3. The electronic device as claimed in claim 1, wherein the housing is made of opaque plastic being or plastic being capable of partially transmitting light.

4. The electronic device as claimed in claim 1, wherein the recesses are formed in the housing by a single injection molding.

5. The electronic device as claimed in claim 1, wherein the recesses are formed in the housing by incising using a machine.

6. The electronic device as claimed in claim 1, wherein electronic device further comprising a printed circuit board in the chamber, on which the at least one light source is located.

7. An electronic device, comprising:
a housing defining a chamber and having a first layer and a transparent second layer, the first layer having an inner surface and an opposite outer surface, the outer surface defining a plurality of light-transmitting recesses configured in a desired pattern, each of the recesses having a gradually changing thickness, the second layer being formed on the outer surface; and
at least one light source fixed in the chamber;
wherein the at least one light source transmits light to the recesses, thereby displaying the desired pattern of the recesses outside the housing.

8. The electronic device as claimed in claim 7, wherein the thickness from open portion to bottom portion of each recess gradually decreases.

9. The electronic device as claimed in claim 7, wherein the first layer is made of opaque plastic being or plastic being capable of partially transmitting light.

10. The electronic device as claimed in claim 7, wherein the second layer is made of transparent plastic.

11. The electronic device as claimed in claim 10, wherein the second layer is formed on the outer surface by injection molding.

12. The electronic device as claimed in claim 7, wherein the recesses are formed in the first layer by a single injection molding.

13. The electronic device as claimed in claim 7, wherein the recesses are formed in the housing by incising using a machine.

14. The electronic device as claimed in claim 7, wherein electronic device further comprising a printed circuit board in the chamber, on which the at least one light source is located.
